(19) United States
(12) Patent Application Publication
(10) Pub. No.: US 2004/0082325 A1
(43) Pub. Date: Apr. 29, 2004

(54) Man-machine interface of wireless access fixed unit

(76) Inventors: Yi-Wen Shih, Taipei City (TW); Hsi-Kun Chen, Tai Chung City (TW); Che-Jen Mou, Tao Yuan Hsien (TW)

Correspondence Address: BIRCH STEWART KOLASCH & BIRCH, PO BOX 747, FALLS CHURCH, VA, 22040-0747, US

(21) Appl. No.: 10/449,394

(22) Filed: Jun. 2, 2003

(30) Foreign Application Priority Data
Oct. 25, 2002 (TW) 91125367

(51) Int. Cl. H04Q 7/20; H04M 11/00

(52) U.S. Cl. 455/426.2; 455/403

(57) ABSTRACT

A man-machine interface of a wireless access fixed unit (WAFU) is described. The wireless access fixed unit locates between a telephone and a wireless local loop. The wireless access fixed unit further has a subscriber module. And, the subscriber module has a protocol unit, which connects with the wireless local loop and has a first protocol layer, a second protocol layer and a third protocol layer. The telephone communicates with the wireless local loop via the protocol unit. The man-machine interface module is disposed in the subscriber module and connects with the telephone and the protocol unit. The man-machine interface module operates between several states to provide a service of conventional wired telephone. The man-machine interface module is capable of making the telephone connected with the wireless access fixed unit operate as a telephone connected with the conventional wired access network.

### FIELD OF THE INVENTION

The present invention is directed to a man-machine interface of a wireless access fixed unit (WAFU), and more particularly, to a man-machine interface disposed in a wireless access fixed unit and located between a wireless local loop and a telephone for providing telecommunication service.

### BACKGROUND OF THE INVENTION

In accordance with the conventional wireless local loop, it is a kind of low-cost and high-capacity wireless technique that can be employed in the building without the trouble of wiring. After setting up the wireless local loop, the subscriber can communicate with other people by using mobile phone. This technique can reduce the cost of network construction. By the way, it would be convenient to subscribers since they would not limited by the wiring.

The technique of wireless local loop is suitable for using in the area that does not have sufficient telecommunication network infrastructure. Since it is not necessary to set up the electric cables for wireless local loop, the construction of wireless local loop is very fast and will not limited by the weather. Therefore, the technique of wireless local loop is very helpful for the area that does not have sufficient telecommunication network infrastructure.

In recent years, a variety of different communication systems of wireless local loop were developed in succession. Therein, digital enhanced cordless telecommunication system (DECT), personal handyphone system (PHS) and personal access communications system (PACS) are well known wireless communication systems internationally. All of these three systems can provide low-mobility and low-power wireless communication. They are suitable to be employed in wireless local loop.

However, every subscriber of these wireless communication systems only can communicate with other people by the mobile phone. It is the same even indoors. Since it is not cost-effective for everyone to possess a mobile phone indoors, the wireless access fixed unit is usually disposed indoors for economy and convenience.

Nevertheless, the wireless access fixed unit still employs the same man-machine interface as that of the mobile phone. As well, the wireless access fixed unit will not generate the dial tone while the telephone handset is picked up. Therefore, the user used to the conventional wired telephone service will hardly get used to the wireless access fixed unit. Besides, the user also cannot know whether the wireless access fixed unit operates normally.

Accordingly, as discussed above, the man-machine interface of the wireless-access fixed unit obviously still has some drawbacks that could be improved. The present invention aims to resolve the drawbacks in the prior art.

### SUMMARY OF THE INVENTION

The present invention is directed to a man-machine interface module of the. wireless access fixed unit. In accordance with the present invention, the proposed man-machine interface module can provide the same service as that of the conventional wired telephone. The man-machine interface module would automatically generate the dial tone, ring tone and busy tone that are generated by the local exchange of the wired access network so as to hide the transmitting differences between the wireless and wired access networks.

For reaching the objective mentioned above, the present invention mainly provides a man-machine interface module of the wireless access fixed unit. The wireless access fixed unit is located between a telephone and a wireless local loop (WLL). The wireless access fixed unit has a subscriber module within which the man-machine interface module is disposed.

The subscriber module includes a protocol unit, which connects with the wireless local loop. The protocol unit includes a first protocol layer, a second protocol layer and a third protocol layer. And, the telephone communicates with the wireless local loop via these three layers.

Moreover, the man-machine interface module connects with the telephone and the protocol unit, respectively. The man-machine interface module operates between several states. By defining each state and each transition between the states, the man-machine interface module can provide the conventional wired telephone service.

The states of the man-machine interface module include a WAIT_REG_ONHOOK state, a WAIT_REG_OFFHOOK state, a IDLE state, a STAND_BY state, a BUILD_CONNECT state, a ALERTING state, a CONVERSATION state and a DISCONNECT state.

By exactly defining these eight states and realizing the transitions between these states, the man-machine interface module can generate a dial tone, busy tone, ring tone or building a connection, so that the users are not necessary to change their habits.

Numerous additional features, benefits and details of the present invention are described in the detailed description, which follows.

### BRIEF DESCRIPTION OF THE DRAWINGS

FIG. 1 is a diagram of the arrangement of a wireless access fixed unit complied with the present invention.

FIG. 2 is a system diagram of the wireless access fixed unit complied with the present invention.

FIGS. 3˜10 are operative flow charts of the man-machine interface module complied with the present invention.

### DETAILED DESCRIPTION

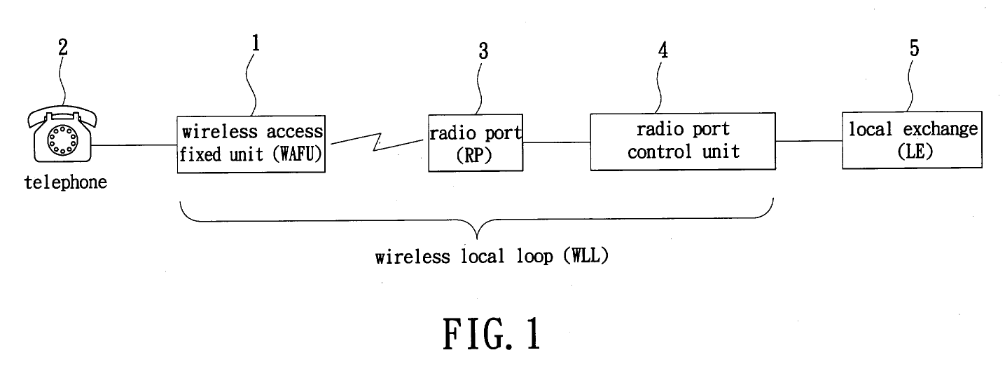

Please refer to FIG. 1 which is the arrangement of a wireless access fixed unit complied with the present invention. The wireless access fixed unit 1 of the present invention connects with the telephone 2 and radio port 3 (RP) by wired and wireless access, respectively. The radio port 3 connects with the radio port control unit 4 (RPCU). In practice, the radio port 3 can connect with the radio port control unit 4 by wireless or wired access. Moreover, the radio port control unit 4 connects with the local exchange 5. Therein, the wireless local loop mentioned above includes the wireless access fixed unit 1, radio port 3 and radio port control unit 4.

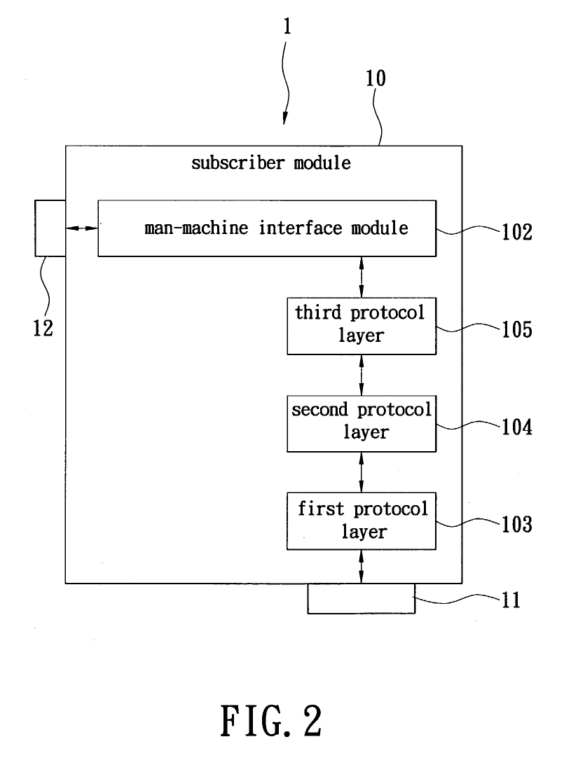

Please refer to FIG. 2 which is the system diagram of the wireless access fixed unit complied with the present invention. The wireless access fixed unit 1 includes a subscriber module 10, a wireless transmission port 11 and a wired transmission port 12. The wireless transmission port 11 and wired transmission port 12 connect with the subscriber module 10 to provide a wireless and wired data, respectively. Moreover, the subscriber module 10 also connects with and sends data to the radio port 3 and telephone 2 via the wireless transmission port 11 and wired transmission port 12, respectively.

Take personal access communications system (PACS) for example. The subscriber module 10 further comprises a man-machine interface module 102, a first protocol layer 103, a second protocol layer 104 and a third protocol layer 105. Therein, the third protocol layer 105 can support the man-machine interface module 102 to provide the functions of authentication, encryption, emergency call, registration, sending a call, receiving a call and ending a call, etc. The second protocol layer 104 can support the third protocol layer 105 to provide the functions of alert, channel access, synchronization, multiplexing/de-multiplexing, segmentation, and signal assembly, etc. Moreover, the first protocol layer 103 can support the second protocol layer 104 to provide physical linking with the radio port 3 and further connect with the radio port control unit 4 via the radio port 3 for communication.

Thereby, the man-machine interface module 102 communicates with the radio port 3 via the first protocol layer 103, second protocol layer 104, third protocol layer 105 and wireless transmission port 11 and communicate with the telephone 2 via the wired transmission port 12 to simulate the conventional wired telephone service. For convenience, the following embodiment will use the key telephone to illustrate the operation of the present invention.

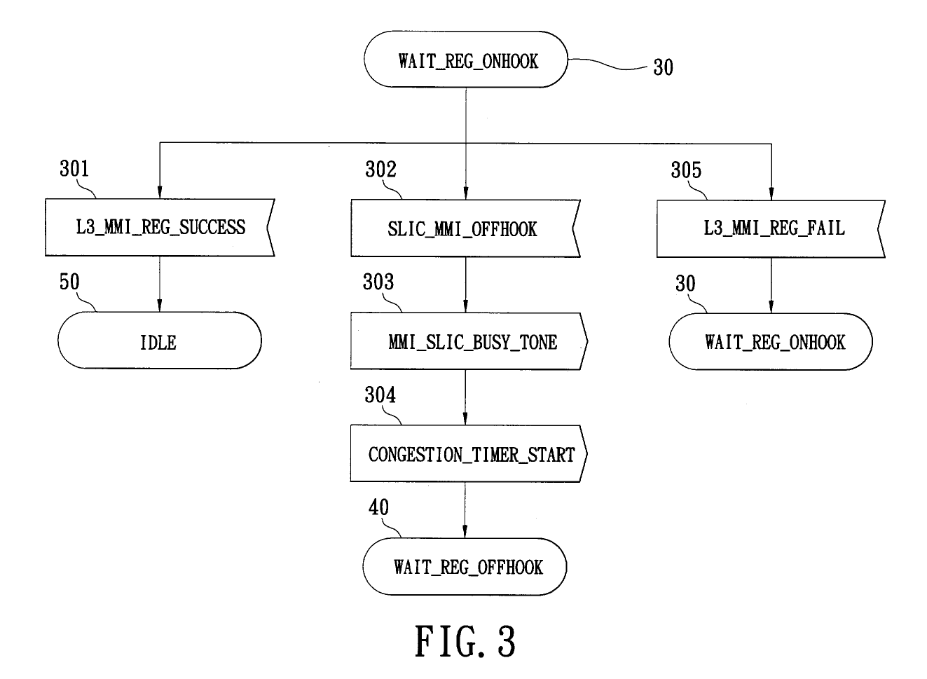

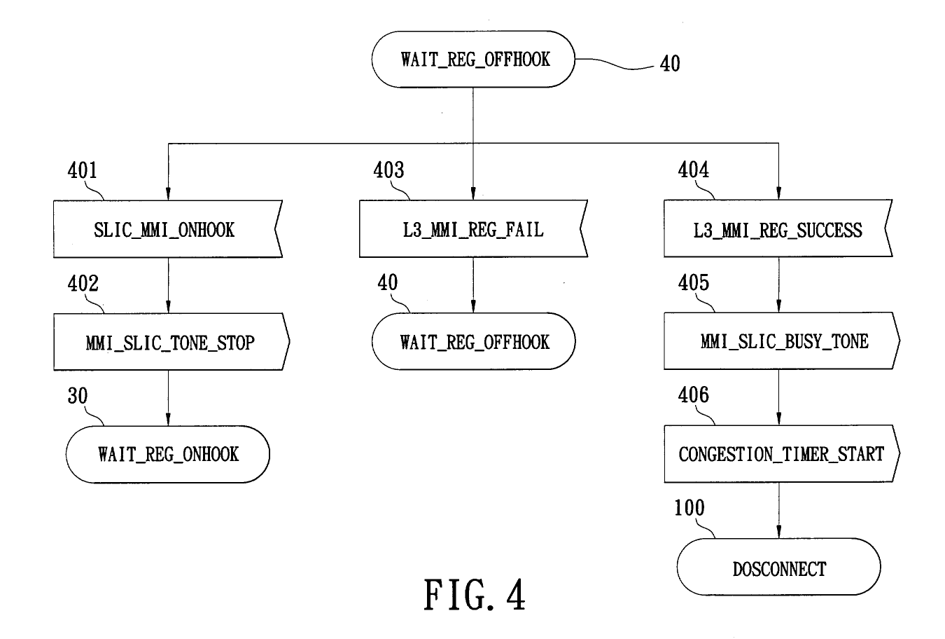

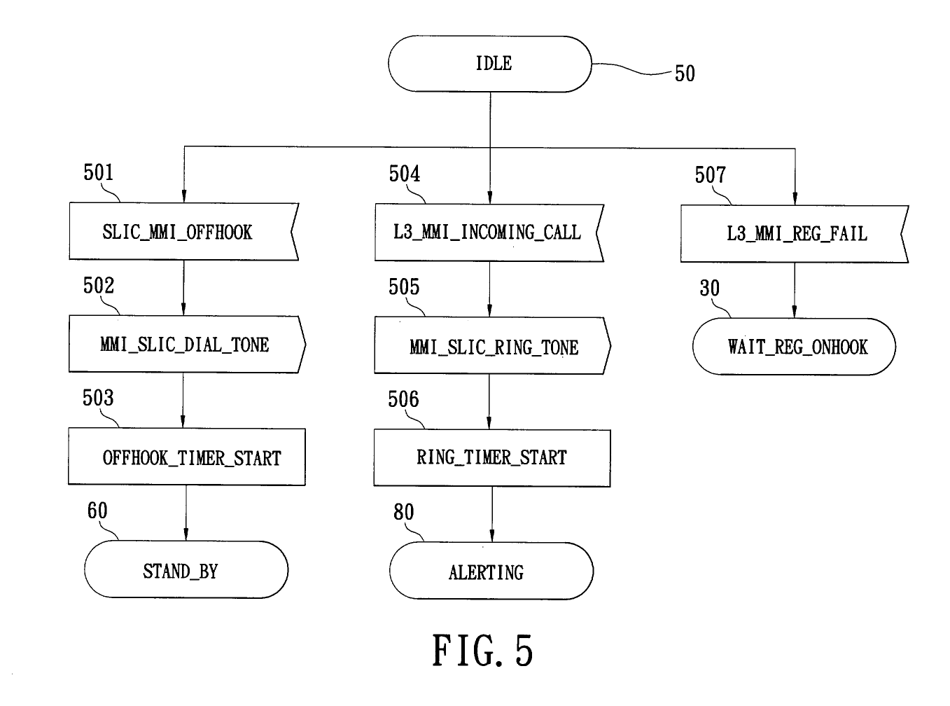

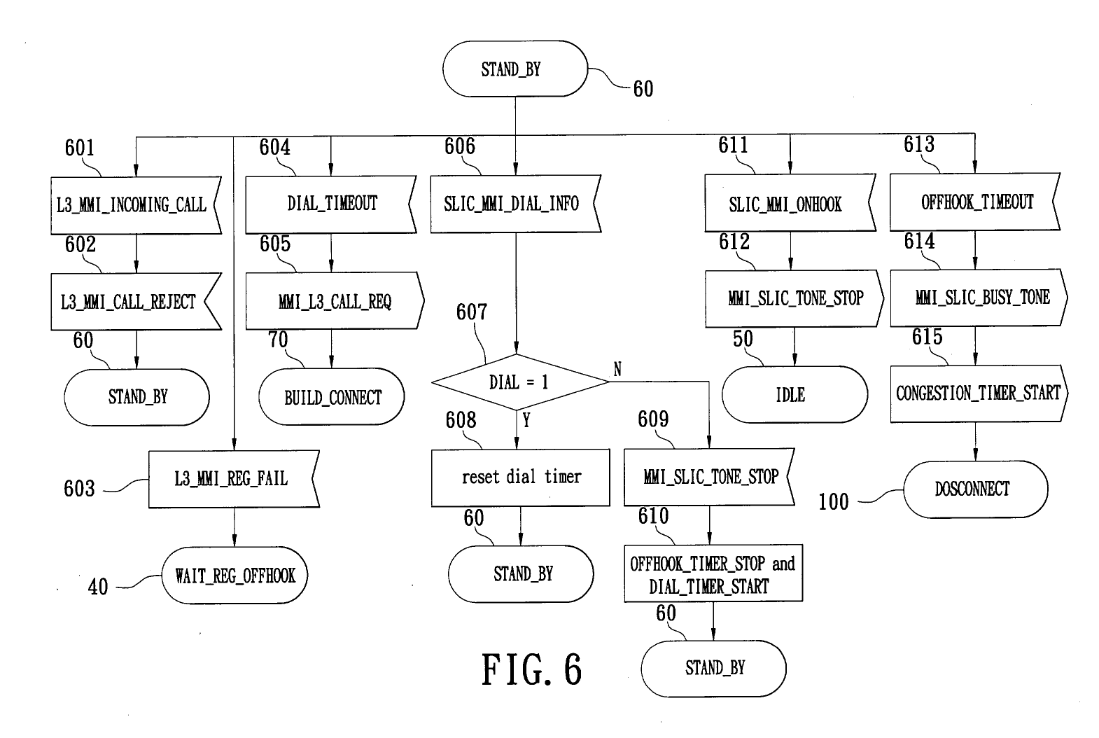

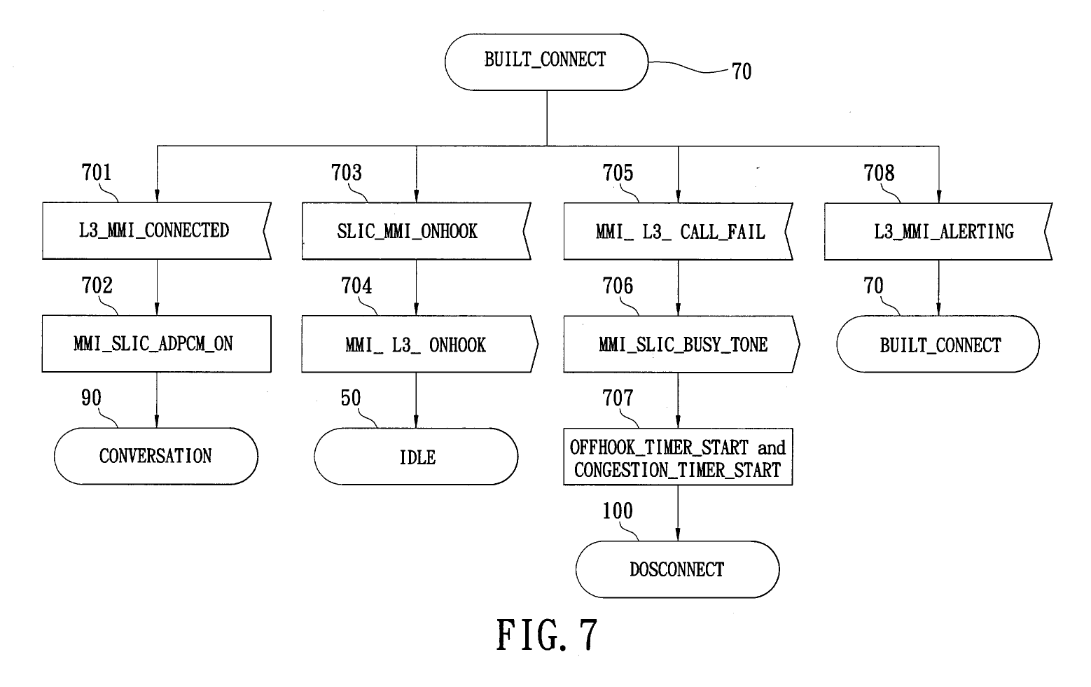

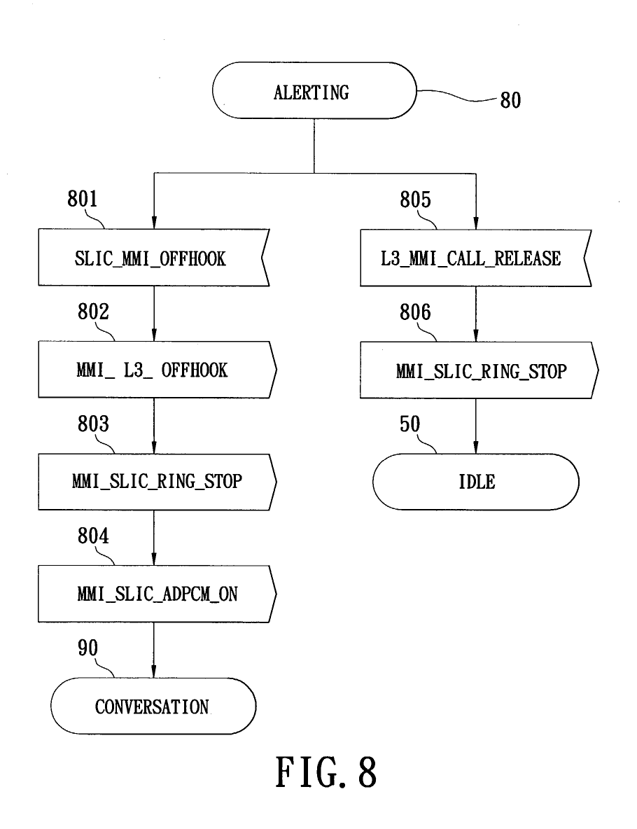

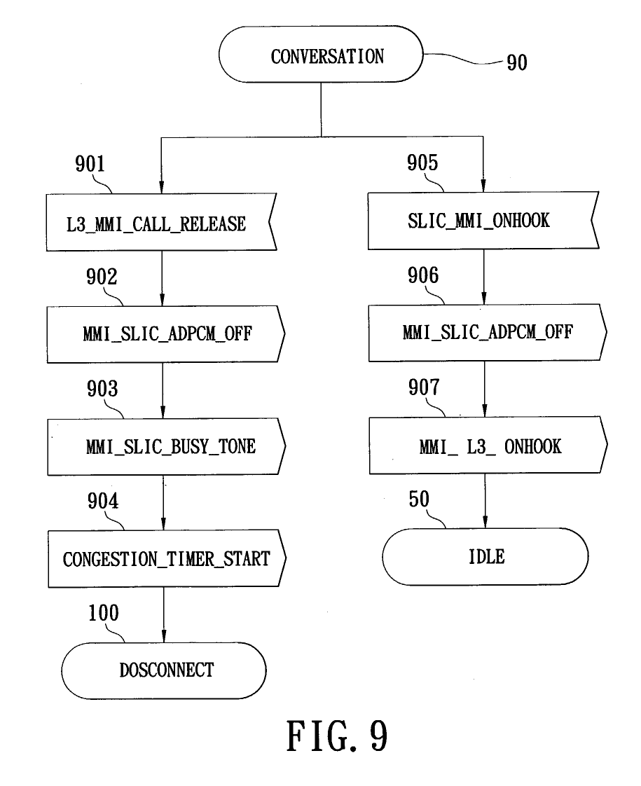

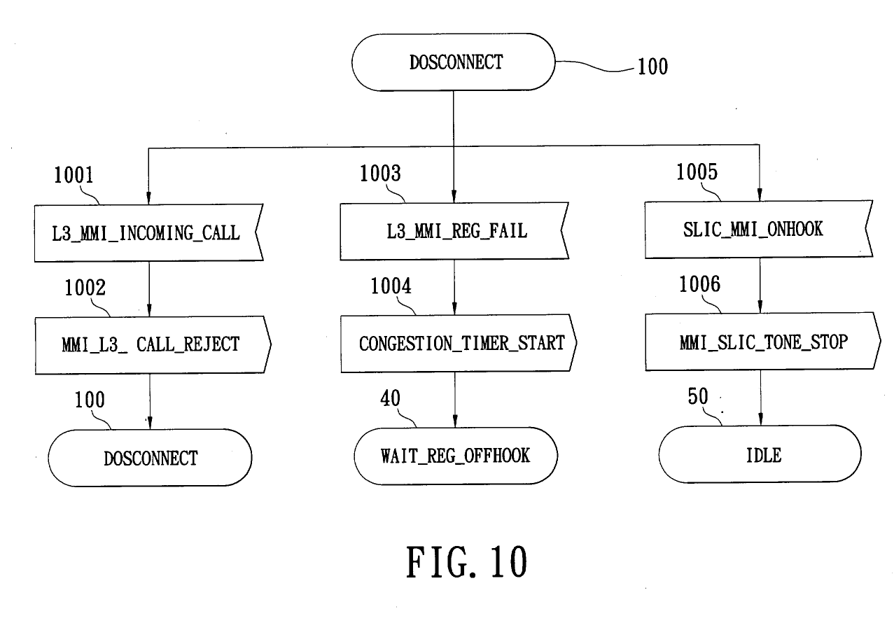

Please refer to FIGS. 3 to 10. The man-machine interface module 102 of the present invention has eight operative states. The meanings of the eight states is described as following:

1. WAIT_REG_ONHOOK state 30: due to the property of wireless communication system, before communicating with the base station, the wireless equipment should register in advance. Therefore, while in this state, it means that the man-machine interface module 102 is waiting for the success of the registration message feedback from the radio port control unit 4 under an on-hook situation.

2. WAIT_REG_OFFHOOK state 40: while in this state, it means that the man-machine interface module 102 is waiting for the registration feedback from the radio port control unit 4 under an off-hook situation.

3. IDLE state 50: this state means that the man-machine interface module 102 has finished the registration under an on-hook situation. In other words, the man-machine interface module 102 is ready for the user to make a phone call or answer the incoming call in this state.

4. STAND_BY state 60: this state indicates that the user has picked up the phone and is going to make a phone call. (The registration should be finished before transiting to this state.)

5. BUILD_CONNECT state 70: this state indicates that the user has dialed a phone number and the man-machine interface module 102 is trying to establish a connection to someone by phone.

6. ALERTING state 80: this state indicates that the phone rings due to an incoming call, i.e., someone is trying to establish a connection to the user.

7. CONVERSATION state 90: this state indicates that the user is speaking to someone else by phone.

8. DISCONNECT state 100: the man-machine interface module 102 enters this state whenever the man-machine interface module 102 is unable to establish a connection or an existing connection is closed.

By employing FIGS. 3˜10, the operation of the man-machine interface module 102 will be described as following. Please note that in the following description each message is presented in (source, destination, command)-format. For example, a message L3_MMI_connected stands for the message sent from the third protocol layer 105 to the man-machine interface module 102 that comes equipped with a CONNECTED command. However, if the source and destination both are man-machine interface module 102, the message will only be presented in (command)-format for simplification. For example, MMI_MMI_BUSY_TONE message will be presented as BUSY_TONE.

Moreover, the wireless access fixed unit 1 further comprises a subscriber line interface circuit (SLIC), which is not shown in the drawings. The subscriber line interface circuit is used to detect the state of the telephone 2, e.g., on-hook or off-hook states.

Please refer to FIG. 3 again. When the man-machine interface module 102 is in the WAIT_REG_ONHOOK state 30, there are three possible conditions as below:

(1) When the man-machine interface module 102 receives L3_MMI_REG_SUCCESS message (step 301), it means that the registration is successful. Afterward the state will transit to the IDLE state 50.

(2) When the man-machine interface module 102 receives SLIC_MMI_OFFHOOK message (step 302), it means that the handset of the telephone 2 is off hook. Then, the man-machine interface module 102 will send out MMI_SLIC_BUSY_TONE message (step 303). During step 303, the telephone 2 will receive a busy tone from the wireless access fixed unit 1. Next, the man-machine interface module 102 will send out the CONGESTION_TIMER_START message to start a congestion timer (step 304). It means that if the user picks up the handset and doesn't dial, the busy tone will be replaced by a congestion tone after a predetermined duration. And, the state will transit to the WAIT_REG_OFFHOOK state 40.

(3) When the man-machine interface module 102 receives L3_MMI_REG_FAIL message (step 305), it means that the registration isn't successful and the state will stay in the WAIT_REG_ONHOOK state 30.

Please refer to FIG. 4. When the man-machine interface module 102 is in the WAIT_REG_OFFHOOK state 40, there are three possible conditions as below:

(1) When the man-machine interface module 102 receives the SLIC_MMI_ONHOOK message (step 401), it means that the handset of the telephone 2 is on hook. Then, the man-machine interface module 102 will sent out the MMI_SLIC_TONE_STOP message to stop the busy tone, congestion tone or dial tone (step 402). And, the state will transit to the WAIT_REG_ONHOOK state 30.

(2) When the man-machine interface module 102 receives the L3_MMI_REG_SUCCESS message (step 404), it means that the registration is completed. Then, the man-machine interface module 102 will sent out the MMI_SLIC_BUSY_TONE message (step 405). In step 405, the telephone 2 will receive a busy tone from the wireless access fixed unit 1. Then, the man-machine interface module 102 will sent out the CONGESTION_TIMER_START message to start the congestion timer (step 406). And, the state will transit to the DISCONNECT state 100.

(3) When the man-machine interface module 102 receives the L3_MMI_REG_FAIL message (step 403), it means that the registration fails. And, the state will stay in the WAIT_REG_OFFHOOK state 40.

Please refer to FIG. 5. When the man-machine interface module 102 is in the IDLE state 50, there are three possible conditions as below:

(1) When the man-machine interface module 102 receives the SLIC_MMI_OFFHOOK: message (step 501), it means that the handset of the telephone 2 is picked up. Then, the man-machine interface module 102 will first send out the MMI_SLIC_DIAL_TONE message (step 502). In step 502, the telephone 2 will receive a dial tone from the wireless access fixed unit 1. In the meanwhile, the man-machine interface module 102 will send out the OFFHOOK_TIMER_START message to start the off-hook timer (step 503). If the handset of the telephone 2 is picked up beyond a predetermined period, the off-hook timer will inform the man-machine interface module 102 to replace the dial tone with a busy tone so that the telephone 2 will receive a busy tone from the wireless access fixed unit 1. And, the state will transit to STAND_BY state 60.

(2) When the man-machine interface module 102 receives the L3_MMI_INCOMING_CALL message (step 504), it means that the telephone receive a phone call. After receiving the phone call, the man-machine interface module 102 will send out a MMI_SLIC_RING_TONE message (step 505) so that the wireless access fixed unit 1 will a ring tone to the telephone 2. Then, the man-machine interface module 102 will send out a RING_TIMER_START message (step 506) to start a ring timer. And, the state will transit to the ALERTING state 80.

(3) When the man-machine interface module 102 receives the L3_MMI_REG_FAIL message (step 507), the state will transit to the WAIT_REG_ONHOOK state 30.

Please refer to FIG. 6. When the man-machine interface module 102 is in the STAND_BY state 60, there are six possible conditions as below:

(1) When the man-machine interface module 102 receives the L3_MMI_INCOMING_CALL message (step 601), the man-machine interface module 102 will send out a MMI_L3_CALL_REJECT: message to reject the incoming call (step 602). And, the state will stay in the STAND_BY state 60.

(2) When the man-machine interface module 102 receives the L3_MMI_REG_FAIL message (step 603), it means that the registration fails and the state will transit to the WAIT_REG_OFFHOOK state 40.

(3) When the man-machine interface module 102 receives the DIAL_TIMEOUT message (step 604), it means that the user did not press any key of the telephone 2 within a predetermined period. Therefore, the man-machine interface module 102 will send out a MMI_L3_CALL_REQ message (step 605) to inform the third protocol layer 105 to build up a connection. And the state will transit to the BUILD_CONNECT state 70.

(4) When the man-machine interface module 102 receives the SLIC_MMI_DIAL_INFO message (step 606), it means that the one key of the telephone 2 has been pressed. Then, the man-machine interface module 102 will have the two kinds of conditions as following (step 607):

(a) If any one key of the telephone 2 is pressed again within a predetermined period (it is counted by a dial timer), the dial timer will be reset (step 608). And, the state will stay in the STAND_BY state 60.

(b) If no key of the telephone 2 is pressed again within a predetermined period, the man-machine interface module 102 will send out a MMI_SLIC_TONE_STOP message (step 609) to inform the subscriber line interface circuit (SLIC) of stopping generating any tone. Then, the man-machine interface module 102 will send out an OFFHOOK_TIMER_STOP and DIAL_TIMER_START message (step 610) to stop the off-hook timer and start the dial timer. And the state will stay in the STAND_BY state 60.

(5) When the user hangs up the telephone 2 without pressing any key, the man-machine interface module 102 will receive a SLIC_MMI_ONHOOK message (step 611). Then, the man-machine interface module 102 will send out a MMI_SLIC_TONE_STOP message (step 612) and the state will transit to the IDLE state 50.

(6) When the man-machine interface module 102 receives the OFFHOOK_TIMEOUT, it means that the user picked up the handset of the telephone 2 without pressed any key beyond a predetermined period (step 613). Then, the man-machine interface module 102 will send out a MMI_SLIC_BUSY_TONE message to inform the subscriber line interface circuit of generating a busy tone (step 614). After that, the man-machine interface module 102 will send out a CONGESTION_TIMER_START message to start a congestion timer (step 615). And, the state will transit to the DISCONNECT state 100.

Please refer to FIG. 7. When the man-machine interface module 102 is in the BUILD_CONNECT state 70, there are four possible conditions as below:

(1) When the man-machine interface module 102 receives the L3_MMI_CONNECTED, it means that a connection has been built up (step 701). Then, the man-machine interface module 102 will send out a MMI_SLIC_ADPCM_ON message (step 702). And, the state will transit to the CONVERSATION state 90. Please note that in the PACS system the adaptive differential pulse code modulation (ADPCM) scheme of ITU G.726 is adopted for the voice coding. The objective of it is to transform the 64 kbps voice data of the standard wired telephone to 32 kbps voice date used by the PACS system. Therefore, ADPCM_ON means that the voice data is being transformed.

(2) When the man-machine interface module 102 receives the SLIC_MMI_ONHOOK (step 703), it means that the user hangs up the telephone 2. Then, the man-machine interface module 102 will send out a MMI_L3_ONHOOK message to inform the third protocol layer 105 that the telephone is hanged up (step 704). And, the state will transit to the IDLE state 50.

(3) When the man-machine interface module 102 receives the L3_MMI_CALL_FAIL message. (step 705), it means that a successful connection with far-end switch can not be established. Then, the man-machine interface module 102 will send out MMI_SLIC_BUSY_TONE message (step 706) to inform the subscriber line interface circuit of generating a busy tone. After that, the man-machine interface module 102 will send out an OFFHOOK_TIMER_START and a CONGESTION_TIMER_START message to start the off-hook timer and congestion timer (step 707). And, the state will transit to the DISCONNECT state 100.

(4) When the man-machine interface module 102 receives the L3_MMI_ALERTING message (step 708), it means that a far-end switch is currently trying to establish a connection with wireless access fixed unit 1. However, since the handset is picked up, the man-machine interface module 102 will ignore it. And, the state will stay in the BUILD_CONNECT state 70.

Please refer to FIG. 8. When the man-machine interface module 102 is in the ALERTING state 80, there are two possible conditions as below:

(1) When the man-machine interface module 102 receives the SLIC_MMI_OFFHOOK message (step 801), it means that the handset of the telephone 2 has been picked up. Then, the man-machine interface module 102 will send out the following messages: 1) the MMI_L3_OFFHOOK message for informing the third protocol layer 105 that the handset has been picked up (step 802); 2). the MMI_SLIC_RING STOP message for informing the subscriber line interface circuit to stop the ring tone (803); 3) the MMI_SLIC_ADPCM_ON message for informing the subscriber line interface circuit to transform the Voice data (step 804). After that, the state will transit to the CONVERSATION state 90.

(2) When the man-machine interface module 102 receives the L3_MMI_CALL_RELEASE message (step 805), it means that a call clearing situation has just been initiated by far-end switch. After that, the man-machine interface module 102 will send out a MMI_SLIC_RING_STOP message to stop the ring tone. And, the state will transit to the IDLE 50 state.

Please refer to FIG. 9. When the man-machine interface module 102 is in the CONVERSATION state 90, there are two possible conditions as below:

(1) When the user would like to stop the conversation and hang up the telephone 2, the man-machine interface module. 102 will receive a SLIC_MMI_ONHOOK message (step 905). Then, the man-machine interface module 102 will first send out a MMI_SLIC_ADPCM_OFF message to inform the subscriber line interface circuit to stop the voice data transforming (step 906). After that, the man-machine interface module 102 will send out a MMI_L3_ONHOOK message to inform the third protocol layer 105 that the telephone 2 has been hanged up. And, the state will transit to the IDLE state 50.

(2) When the man-machine interface module 102 receives the L3_MMI_RELEASE_CALL message (step 901), it means that the call has been terminated by far-end switch. After that, the man-machine interface module 102 will send out the following messages: 1) the MMI_SLIC_ADPCM_OFF message for informing the subscriber line interface circuit to stop the voice data transforming (step 902); 2) the MMI_SLIC_BUSY_TONE message for informing the subscriber line interface circuit to generate a busy tone (step 903). In the meantime, the man-machine interface module 102 will send out the CONGESTION_TIMER_START message to start the congestion timer (step 904). And, the state will transit to the DISCONNECT state 100.

Please refer to FIG. 10. When the man-machine interface module 102 is in the DISCONNECT state 100, there are three possible conditions as below.

(1) When the man-machine interface module 102 receives the L3_MMI_INCOMING_CALL message (step 1001), it means that there is an incoming call. However, since the connection can not be built up at this moment, the man-machine interface module 102 will thus send out a MMI_L3_CALL_REJECT message to reject the call request issued by far-end switch (step 1002). And, the state will stay in the DISCONNECT state 100.

(2) When the man-machine interface module 102 receives the L3_MMI_REG_FAIL message (step 1003), it means that the registration fails. Then, the man-machine interface module 102 will send out a CONGESTION_TIMER_START message to start the congestion timer (step 1004). And, the state will transit to the WAIT_REG_OFFHOOK state 40.

(3) When the man-machine interface module 102 receives the SLIC_MMI_ONHOOK message (step 1005), it means that the telephone 2 has been hanged up. Then, the man-machine interface module 102 will send out A MMI_SLIC_TONE_STOP message to inform the subscriber line interface circuit to stop the voice tone. And, the state will transit to the IDLE state 50.

Accordingly, the present invention has the following features:

(1) The present invention can connect the conventional wired telephone with the wireless local loop.

(2) The present invention has eight operation states, which are the WAIT_REG_ONHOOK state, WAIT_REG_OFFHOOK state, IDLE state, STAND_BY state, BUILD_CONNECT state, ALERTING state, CONVERSATION state and DISCONNECT state.

(3) By well defining the eight states and the transitions between these states, the present invention can make the telephone connected with the wireless access network have the same functions as that connected with the conventional wired access network.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A man-machine interface module of a wireless access fixed unit, the wireless access fixed unit located between a telephone and a wireless local loop, the wireless access fixed unit further having a subscriber module comprising:
a protocol unit connecting with the wireless local loop, having a first protocol layer, a second protocol layer and a third protocol layer, the telephone communicating with the wireless local loop via the protocol unit;
the man-machine interface module being disposed in the subscriber module, which connects with the telephone and the protocol unit and operates between a plurality of states to provide a service of conventional wired telephone.

2. The man-machine interface module as claimed in claim 1, wherein the states comprise a WAIT_REG_ONHOOK state, which indicates that the man-machine interface module is waiting for a success of a registration under an on-hook situation.

3. The man-machine interface module as claimed in claim 1, wherein the states comprise a WAIT_REG_OFFHOOK state, which indicates that the man-machine interface module is waiting for a success of a registration under an off-hook situation.

4. The man-machine interface module as claimed in claim 1, wherein the states comprise an IDLE state, which indicates that a registration is completed under an on-hook situation.

5. The man-machine interface module as claimed in claim 1, wherein the states comprise a STAND_BY state, which indicates that a handset of the telephone is picked up and the man-machine interface module is ready for a user to make a phone call.

6. The man-machine interface module as claimed in claim 1, wherein the states comprise a BUILD_CONNECT state, which indicates that a user has dialed a phone number and the man-machine interface module is trying to establish a connection.

7. The man-machine interface module as claimed in claim 1, wherein the states comprise an ALERTING state, which indicates that there is an incoming call trying to establish a connection with the telephone.

8. The man-machine interface module as claimed in claim 1, wherein the states comprise a CONVERSATION state, which indicates that the telephone is under a conversation situation.

9. The man-machine interface module as claimed in claim 1, wherein the states comprise a DISCONNECT state, which indicates that a connection building fails or a connection is ended.
